(19) United States
(12) Patent Application Publication
(10) Pub. No.: US 2022/0389350 A1
(43) Pub. Date: Dec. 8, 2022

(54) CLEANING COMPOSITION AND METHOD FOR REMOVAL OF STAINS FROM ROOF SHINGLES

(71) Applicant: W.M. Barr & Company, Inc., Memphis, TN (US)

(72) Inventors: Rachel Ann FARMER, Memphis, TN (US); Matthew Michael PETKUS, Memphis, TN (US)

(21) Appl. No.: 17/832,190

(22) Filed: Jun. 3, 2022

Related U.S. Application Data
(60) Provisional application No. 63/197,006, filed on Jun. 4, 2021.

(51) Int. Cl. C11D 1/94; C11D 1/62; C11D 1/90; C11D 3/00; C11D 3/43

(52) U.S. Cl. CPC C11D 1/94; C11D 1/62; C11D 1/90; C11D 3/0047; C11D 3/43

(57) ABSTRACT

A composition is provided containing a pH adjuster, a surfactant, and a solvent, wherein the composition has the ability to solubilize MAAs that creates dark streaks on roof shingles. The method of making the composition involves mixing a pH adjuster and a surfactant with water. A method of using is provided in which additional water is added to the composition. Once the composition is diluted and the desired alkalinity is reached, the composition is sprayed on a roof through a device having a spray/stream end. The output from the spray/stream end of the device transforms secreted MAA present on the roof shingles into an orange color upon contact. The resulting orange residue is then rinsed off from the shingles to provide a new looking roof.

### CROSS-REFERENCE TO RELATED APPLICATION

This application claims priority from U.S. provisional patent application No. 63/197,006, filed on Jun. 4, 2021, in the United States Patent and Trademark Office. The disclosure of which is incorporated herein by reference in its entirety.

### FIELD OF THE INVENTION

The present invention relates to a composition and method for cleaning and/or removing dark marks appearing on roof shingles, more particularly to a composition and method for solubilizing mycosporine-like amino acids (MAA) on shingles of roofs.

### BACKGROUND OF THE INVENTION

A common problem that homeowners face with their roofs is the eroding shingle color and the dark streaks that replace the original color over time. More specifically, if one were to look at a roof facing the north—where the roof is not exposed directly to harsh sunlight—one might notice that the north facing side of the roof looks darker than the other sides. This discoloration on a home can have an unsightly presence and can affect a homeowners' sense of pride that comes from the upkeep of their homes and the appearance of their home. This discoloration can also lead to a sense of fear that the roof is aging more quickly than a homeowner would find acceptable.

Therefore, a need exists to create a product that is easy to apply to a roof with results that can be distinguished quickly to remove the soil that creates these dark streaks from the roof shingles and make the roof appear as if it were brand new. Current products on the marketplace include either the use of hose-end bleach base products or the use of quaternary ammonium compounds (quat) based formulas. Bleach base products, although highly effective, come with disadvantages such as a strong odor, unwanted destruction of plant life around the area of cleaning, and even severe damages to the roof structure if the wrong concentration is used. On the other hand, quat based formulas can take an extended period of time before acquiring any results and are often dependent on the weather and amount of rainfall. Current quat based products on the market can take up to one year before showing any results in the color of the roof. Thus, with these considerations, a need exists to create the next generation of non-bleach base roof cleaning products.

Initial research on the type of soil found on shingles led to literature on mycosporine-like amino acids (MAA). These are believed to be secreted by organisms that feed off the limestone from asphalt shingles and thus grow on the roof. Gravity pulls these stains down the roof and causes an unsightly black and green discoloration to a person's home.

Thus, there is a need for a product to address and solve the roof discoloration created from the MAA. A cleaning composition for shingles on roofs is desired to overcome the known disadvantages of current roof cleaning products on the market.

### SUMMARY OF THE INVENTION

The present invention relates to a novel chemical composition and method for removing MAAs that create dark streaks typically found on older roof shingles.

In an embodiment of the invention, a composition is provided. The composition comprises a pH adjuster and a surfactant, wherein the composition is capable of solubilizing mycosporine or mycosporine-like amino acids (MAA) secreted by an organism.

In an embodiment of the invention, the composition may be in a form of a concentrate. The concentrate may be diluted to provide the appropriate alkalinity post dilution on a roof as applied through a hose-end sprayer.

In an embodiment of the invention, a method of making is provided. The method of making comprises mixing a pH adjuster, a surfactant, and a solvent

In an embodiment of the invention, a method of using is provided. The method of using comprises providing a composition comprised of a pH adjuster, a surfactant, and a solvent; adding water to the composition to form a diluted composition having a pH of 12 or above 12; and applying the diluted composition to a roof having stains thereon.

A novel feature of this composition and method includes a color change that becomes visibly apparent to the person applying the chemistry. When the composition is applied, an orange color appears on the roof shingles signaling that the MAA has been solubilized. This informs a user to rinse the roof signaling that the composition has had the desired effect.

Additionally, consumers will notice a more immediate result compared to a quat containing product that can take months to achieve desired results.

Also, the results of this composition are similar to the results achieved by bleach cleaning products but without the harsh bleach smell or other risk factors to surrounding plants and substrates.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a graph illustrating a curve generated using 45% KOH versus pH to determine amount of caustic to obtain a pH of 12 or >12.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in,” “at,” and/or “on,” unless the context clearly indicates otherwise. The phrase “in one embodiment,” as used herein does not necessarily refer to the same embodiment, although it may.

The composition of the present invention is capable of solubilizing mycosporine or mycosporine-like amino acids (MAA) secreted by organisms feeding off roof shingles. The composition can solubilize the secreted MAA thereby providing an orange color upon contact that is then able to be rinsed off the shingles of the roof in order to provide a roof free of dark streaks. The roof therefore has a newer looking appearance. Thus, the composition is used to minimize dark streak appearances found on older roof shingles.

The composition of the present invention comprises a pH modifying substance, also referred to herein as a pH adjustor, in an amount sufficient to adjust the pH level of the applied composition to a pH value of 12 or above 12, preferably a pH value of 12.5 or above 12.5. This high alkalinity is used to solubilize the MAA on the roof.

Preferably, a pH at 12 or above 12 is desired to clean the shingle, and more preferably a pH greater than 12.5. Various pH adjustors can be used to achieve this pH. The pH adjuster is preferably a caustic. Examples of pH adjustors include, but are not limited to, sodium hydroxide, magnesium hydroxide, potassium hydroxide, ammonium hydroxide, calcium hydroxide (or other alkali metal salts or alkali earth metal salts), amines, carbonates, sodium metasilicate, and a combination thereof.

The composition of the present invention comprises a surfactant. The surfactant is used in the composition to wet the surface of the roof and penetrate the MAA layer before it is solubilized. The surfactant in the composition provides wetting and foaming properties to coat the surface of the roof shingle as well as provide the consumer with a visual reference to know where the composition has been applied and to serve as indicator that the composition is working.

A broad range of surfactants may be used in the composition of the present invention including, but not limited to, nonionic surfactants, anionic surfactants, cationic surfactants, amphoteric surfactants, and a combination thereof. A balance of maintaining water solubility, manufacturability, and biodegradability are factors when choosing the surfactant system.

Nonionic and anionic surfactants are preferred for their wetting and foaming properties. Examples of nonionic surfactants include, but are not limited to, ethylene oxide, ethoxylated surfactants, alkyl phenol ethoxylated, sorbitan ester ethoxylates, fatty amine ethoxylates, and a combination thereof. Various chain lengths and ethoxylation may be used if solubility in water is maintained.

Amphoteric surfactants, such as n-alkyl betaines and amine oxides, may be used as they behave like anionics in alkaline pH solutions. An example of a preferred amine oxide as a amphoteric aqueous surfactant is lauryl dimethylamine oxide. Other amine oxides may be used such as an amine oxide having a chain length of C8-C18. Amphoteric surfactants may also be combined with cationic surfactants, such as quaternary ammonium compounds including, but not limited to, benzyl-c12-c16-alkydimethyl chloride, to provide long term cleaning.

Anionic surfactants may also be used in the composition of the present invention. Examples of anionic surfactants include, but are not limited to, carboxylates, sulphates, sulphonates, phosphates, and a combination thereof.

Cationic surfactants can be used including, but not limited to, quaternary ammonium compounds and/or silane quaternary ammonium compounds. An amine oxide can be used in combination with a quaternary ammonium compound including, but not limited to, benzyl-c12-c16-alkydimethyl chloride. An amine oxide can also be used in combination with a silane quaternary ammonium compound including, but not limited to, 3-trimethoxysilyl propyl dimethyl octadecyl ammonium chloride.

An example would be to use lauramine oxide (or lauryl dimethylamine oxide) in combination with a silane quaternary ammonium compound such as 3-trimethoxysilyl propyl dimethyl octadecyl ammonium chloride.

The composition may further comprise a solvent. The solvent is preferably water. Additional solvents can be added to increase cleaning performance such as glycol ethers. Non-limiting examples of glycol ethers are 2-(2-butoxyethoxy)ethan-1-ol and ethylene glycol monobutyl ether (commercially available as Butyl CELLOSOLVE™ solvent from Dow).

The composition may be in a concentrated form such that the composition is diluted when attached to a water hose or other spray device and streamed and/or sprayed. In concentrated form, the caustic is in a range of 0.5% to 20% by weight, preferably 0.5% to 5% by weight, wherein the weight is based on the total weight of the composition. In concentrated form, the surfactant is in a range of 0.2% to 45% by weight, preferably 0.2% to 30% by weight, wherein the weight is based on the total weight of the composition. The solvent is the balance of the composition by weight, wherein the weight is based on the total weight of the composition.

In an embodiment of the present invention, the composition comprises of a caustic, lauryl dimethylamine oxide, and water.

Due to the caustic nature of the composition, compatibility with bottle resin should be considered. Initial evaluation of the composition in HDPE resin holding 30 hours of environmental stress crack resistance (ESCR) testing showed failures on the bottles. An example of this type of resin is B53-35H-011 polyethylene copolymer. Therefore, it was determined that an HDPE bottle with higher ESCR properties was desired to hold the caustic formula. Non-limiting examples of acceptable resins include, but are not limited to, Marlex HXM 50100-01 Polyethylene and Petrothene® LP5002 which have ESCR values of >600 hours and >1000 hours, respectively.

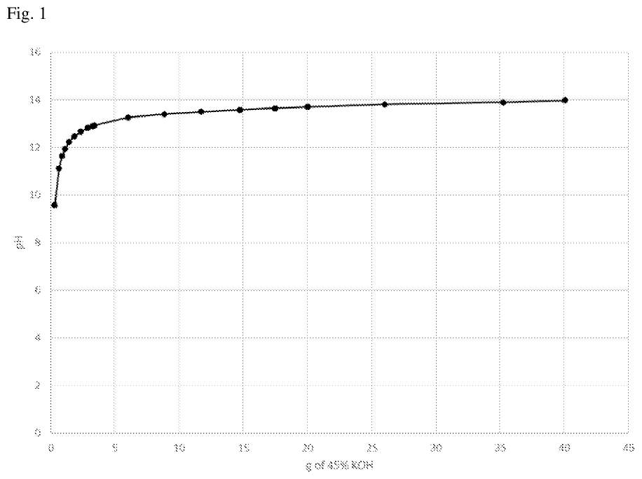

Referring now to the figures, FIG. 1 illustrates a standard curve generated using 45% KOH to determine amount of caustic needed to obtain a pH of 12 or greater than 12, preferably a pH of 12.5 or greater than 12.5. The curve also illustrates the caustic needed to obtain a desired pH post-dilution through a hose-end spray/stream device which includes, but is not limited to, a hose-end device with a dilution factor of 1:15 (i.e. 1 part concentrate to 15 parts water running through the hose end device). In order to have the diluted pH be at or above 12, and more preferably 12.5, the concentrated solution in the bottle has a pH 14.

In an embodiment of the invention, a method of making the composition is provided. The method generally comprises mixing a pH adjuster, a surfactant, and a solvent, in no particular order.

In an embodiment of the invention, a method of using the composition is provided. The method comprises: providing a bottle having a device such as a nozzle attached thereto with a hose-end and a spray/stream end, the bottle containing a composition comprising a pH adjuster, a surfactant, and a solvent; attaching a water hose to the hose-end of the device in order to add water to the composition thereby forming a diluted composition having a pH of 12 or above 12; and applying the diluted composition from the spray/stream end of the device to a roof having dark stains. After dilution in order to achieve the desired alkalinity, the desired output is typically a diluted composition comprising approximately 1 weight % of a pH adjuster, approximately 1.5 weight % surfactant, and approximately 97.5 weight % water. Examples of common dilution ratios provided by the nozzles of the devices having the hose-end and the spray/stream end are 1 part concentrate to 9 parts water, or 1 part concentrate to 15 parts water. Any number of dilution ratios are possible as different size bottles may be employed and a consumer may dilute to different ratios such as 1:5 or 1:7 or others, for example.

Once the water from the hose mixes with the composition, a foam is created and applied to the roof. The foam is rinsed off with water after a bright orange color appears on the roof. This color change indicates that the MAA has been solubilized, and the roof is ready to be rinsed off with clean water. A novel feature of the composition of the present invention is the color change that is visible to a person applying the chemistry. When the composition is applied to MAA on roof shingles, a color change to a bright orange color occurs which then can be rinsed away to achieve a cleaner, newer looking roof.

### EXAMPLE

A composition comprising a pH adjuster and a surfactant was used, such as the pH adjuster being 45% KOH solution and the surfactant being 30% active lauryl amine oxide, having the capability of solubilizing mycosporine or mycosporine-like amino acids (MAA) secreted by an organism were applied to a selected spot on a roof of a house. A bright orange color was created by applying the chemical composition to the selected spot on the roof. The composition was subsequently rinsed off after being applied. As a result, dark streaks were removed from that specific area of the roof. A before photograph of the roof was taken before application of the composition with a hose-end device, and an after photograph of the roof was taken after the composition was sprayed onto the roof and then the roof rinsed. The after photograph was taken within 2 weeks after application and showed dark streaks were removed from that specific area of the roof.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A composition comprising:
a pH adjuster, and
a surfactant,
wherein the composition is capable of solubilizing mycosporine or mycosporine-like amino acids (MAA) secreted by an organism.

2. The composition according to claim 1, wherein the pH adjuster adjusts the pH of the composition to 12 or above 12.

3. The composition according to claim 1, wherein the pH adjuster adjusts the pH of the composition to 12.5 or above 12.5.

4. The composition according to claim 1, wherein the pH adjuster is a caustic.

5. The composition according to claim 1, wherein the pH adjuster is selected from the group consisting of sodium hydroxide, magnesium hydroxide, potassium hydroxide, ammonium hydroxide, calcium hydroxide or other alkali metal salts or alkali earth metal salts, amines, carbonates, sodium metasilicate, and a combination thereof.

6. The composition according to claim 1, wherein the surfactant is selected from the group consisting of nonionic, anionic, amphoteric, cationic, and a combination thereof.

7. The composition according to claim 6, wherein the surfactant is amphoteric.

8. The composition according to claim 7, wherein the amphoteric surfactant is a n-alkyl betaine or an amine oxide.

9. The composition according to claim 8, wherein the amine oxide has a chain length of C8-C18.

10. The composition according to claim 8, wherein the amine oxide is lauryl dimethylamine oxide.

11. The composition according to claim 7, wherein the amphoteric surfactant is used in combination with a cationic surfactant.

12. The composition according to claim 11, wherein the cationic surfactant is a quaternary ammonium compound.

13. The composition according to claim 12, wherein the quaternary ammonium compound is benzyl-c12-c16-alkydimethyl chloride.

14. The composition according to claim 11, wherein the cationic surfactant is a silane quaternary ammonium compound.

15. The composition according to claim 14, wherein the silane quaternary ammonium compound is 3-trimethoxysilyl propyl dimethyl octadecyl ammonium chloride.

16. The composition according to claim 1, wherein the composition further comprises a solvent.

17. The composition according to claim 16, wherein the solvent is selected from the group consisting of water, a glycol ether, and a combination thereof.

18. The composition according to claim 17, wherein the glycol ether is selected from the group consisting of 2-(2-butoxyethoxy)ethan-1-ol, ethylene glycol monobutyl ether, and a combination thereof.

19. A composition comprising:
a caustic, and
lauryl dimethylamine oxide.

20. The composition according to claim 19, further comprising water.

21. The composition according to claim 19, wherein the caustic is present in a range of 0.5% to 20% by weight, wherein the weight percentage is based on the weight of the total composition.

22. The composition according to claim 21, wherein the caustic is present in a range of 0.5% to 5% by weight, wherein the weight percentage is based on the weight of the total composition.

23. The composition according to claim 19, wherein the lauryl dimethylamine oxide is present in a range of 0.2% to 45% by weight, wherein the weight percentage is based on the weight of the total composition.

24. The composition according to claim 23, wherein the lauryl dimethylamine oxide is present in a range of 0.2% to 30% by weight, wherein the weight percentage is based on the weight of the total composition.

25. The composition according to claim 19, wherein a balance of water is present.

26. The composition according to claim 1, wherein the composition is housed in a container or bottle having an environmental stress crack resistance (ESCR) value of >600 hours.

27. The composition according to claim 19, wherein the composition is housed in a container or bottle having an environmental stress crack resistance (ESCR) value of >1000 hours.

28. A method for making a composition, the method comprising:
mixing a pH adjuster, a surfactant, and a solvent.

29. The method according to claim 28, wherein the solvent is selected from the group consisting of water, a glycol ether, and a combination thereof.

30. A method of using, the method comprising:
providing a composition comprised of a pH adjuster, a surfactant, and a solvent;
adding water to the composition to form a diluted composition having a pH of 12 or above 12; and
applying the diluted composition to a roof having stains thereon.

31. The method according to claim 30, wherein the pH adjuster adjusts the pH of the composition to 12.5 or above 12.5.

32. The method according to claim 30, further comprising rinsing the applied composition once after an orange color change is visible on the roof.

33. The method according to claim 30, wherein the pH adjuster is a caustic.
